(19) United States
(12) Patent Application Publication
(10) Pub. No.: US 2016/0346865 A1
(43) Pub. Date: Dec. 1, 2016

(54) RESISTANCE SPOT WELDING WORKPIECE STACK-UPS OF DIFFERENT COMBINATIONS OF STEEL WORKPIECES AND ALUMINUM WORKPIECES

(71) Applicant: GM GLOBAL TECHNOLOGY OPERATIONS LLC, Detroit, MI (US)

(72) Inventors: David R. Sigler, Shelby Township, MI (US); Blair E. Carlson, Ann Arbor, MI (US); Susan M. Smyth, Rochester Hills, MI (US); John Patrick Spicer, Plymouth, MI (US)

(21) Appl. No.: 14/722,563

(22) Filed: May 27, 2015

(51) Int. Cl. B23K 11/11; B23K 11/20; B23K 11/18; B23K 11/31

(52) U.S. Cl. CPC B23K 11/115; B23K 11/312; B23K 11/20; B23K 11/185

(57) ABSTRACT

A method of resistance spot welding workpiece stack-ups of different combinations of steel workpieces and aluminum workpieces includes several steps. In one step, a workpiece stack-up is brought between a first weld gun arm and a second weld gun arm. The first weld gun arm includes a first welding electrode, and the second weld gun arm includes a carrier that supports a second welding electrode and a third welding electrode. Another step involves rotating the carrier and passing electrical current through the workpiece stack-up using the first welding electrode in conjunction with either the second welding electrode or the third welding electrode depending on which electrode has been rotated into facing alignment with the first welding electrode.

### TECHNICAL FIELD

The technical field of this disclosure relates generally to resistance spot welding and, more particularly, to resistance spot welding procedures for workpiece stack-ups of different combinations of steel and aluminum workpieces that demand different welding electrodes.

### BACKGROUND

Resistance spot welding is a process used in a number of industries to join together two or more metal workpieces. The automotive industry, for instance, often uses resistance spot welding to join together metal workpieces during the manufacture of a vehicle door, hood, trunk lid, or lift gate, among other vehicle components. Multiple resistance spot welding events are typically performed along a periphery of the metal workpieces or at some other location. While spot welding has been practiced to join together certain similarly-composed metal workpieces—such as steel-to-steel and aluminum-to-aluminum—the desire to incorporate lighter weight materials into a vehicle body structure has created interest in joining steel workpieces to aluminum or aluminum alloy (referred to collectively as “aluminum” for brevity) workpieces by resistance spot welding. Moreover, the ability to resistance spot weld workpiece stack-ups containing different workpiece combinations (e.g., aluminum/aluminum, steel/steel, and aluminum/steel) in an efficient and effective manner would increase production flexibility and reduce manufacturing costs.

Resistance spot welding, in general, relies on the resistance to the flow of electrical current through superposed contacting metal workpieces and across their faying interface to generate heat. To carry out a resistance spot welding process, a set of opposed welding electrodes is clamped at aligned spots on opposite sides of the workpiece stack-up, which typically includes two or three metal workpieces arranged in a lapped configuration, at a weld site. An electrical current is then passed through the metal workpieces from one welding electrode to the other. Resistance to the flow of the electrical current generates heat within the metal workpieces and at their faying interface(s). When the workpiece stack-up includes a steel workpiece and an aluminum workpiece, for instance, the heat generated at the faying interface initiates and grows a molten aluminum alloy weld pool that penetrates into the aluminum workpieces from the faying interface. The molten aluminum alloy weld pool wets the adjacent faying surface of the steel workpiece and, upon cessation of the current flow, solidifies into a weld joint that bonds the workpieces together. When, on the other hand, the workpiece stack-up includes adjacent aluminum workpieces or adjacent steel workpieces, the heat generated at the faying interface initiates and grows a molten aluminum weld pool or a molten steel weld pool, respectively, that penetrates into each workpiece. Upon cessation of the electrical current, the molten weld pool solidify into a weld nugget that fuses the two workpieces together.

Different welding electrodes are oftentimes used depending on whether the welding electrodes will be brought into pressed contact with a steel workpiece or an aluminum workpiece during a resistance spot welding event. Welding electrodes designed for use with steel workpieces typically have a weld face with a diameter of 5 mm to 10 mm and a radius of curvature of 40 mm to flat. Welding electrodes designed for aluminum workpieces, on the other hand, typically have a weld face with a diameter of 6 mm to 20 mm and a radius of curvature of 12 mm to 300 mm. The two classes of welding electrodes may also be composed of different materials. One solution to spot weld adjacent aluminum workpieces or adjacent steel workpieces is via use of dedicated and distinct weld guns—one with welding electrodes for steel, and one with welding electrodes for aluminum—which could be interchanged as needed amid a resistance spot welding process that encounters different stack-ups. Or, as an alternative, a dressing step could be carried out to alter the weld face geometry of a single welding electrode each time the workpiece it would be contacting was changed from steel to aluminum or vice versa. These measures are unsuitable in some cases since they may add cost and time to the overall spot welding process, may occupy floor space that is oftentimes limited in a manufacturing setting, and may pose yet other issues.

### SUMMARY OF THE DISCLOSURE

A method of resistance spot welding workpiece stack-ups of different combinations of steel workpieces and aluminum or aluminum alloy (“aluminum” for brevity) workpieces is disclosed. The method involves the use of a welding gun arm with a rotatable carrier that supports at least two welding electrodes. The carrier promptly exchanges the welding electrodes via rotation, as needed, as steel and aluminum workpiece combinations are made available for resistance spot welding. Any one of a steel-to-steel workpiece stack-up, an aluminum-to-aluminum workpiece stack-up, or steel-to-aluminum workpiece stack-up can be resistance spot welded together at any time on a single welding operation line with use of the carrier. The carrier may be equipped on only one of the two weld gun arms that together perform resistance spot welding, or it may be equipped on both weld gun arms.

The welding electrodes supported on the carrier may be the same or different in construction. For example, one welding electrode may be configured for spot welding steel workpieces, and the other welding electrode may be configured for spot welding aluminum workpieces. As another example, one welding electrode may be configured for spot welding thin gauge steel workpieces, and the other welding electrode may be configured for spot welding thick gauge steel workpieces. Still further, as another example, one welding electrode may be configured for spot welding thin gauge aluminum workpieces, and the other welding electrode may be configured for spot welding thick gauge aluminum workpieces. Another example contemplates that both welding electrodes could be configured for spot welding workpieces of similar materials and similar constructions.

As it exchanges the welding electrodes, the carrier may be indexed to different positions in order to use the welding electrode most suited for the particular workpiece stack-up being resistance spot welded (e.g., steel-to-steel, an aluminum-to-aluminum, or steel-to-aluminum) at that time. The carrier may be indexed to each of its different positions by an indexing feature that may include many designs and constructions including, for example, a protrusion and a recess mated together. For example, a protrusion may extend from the weld gun arm and a recess associated with each of the different positions of the carrier may be located in the carrier. In this example, the protrusion may be received in and mated with one of the recesses to provide an indexing feature that indexes the carrier to one position, and then, after rotation of the carrier, the same protrusion may be received in a mated with another recess to provide another indexing feature that indexes the carrier to another position. Of course, in another example, a recess may be located in the weld gun arm and protrusion associated with each of the different positions of the carrier may extend from the carrier to achieve the same indexing mechanics.

The indexing feature may also participate in the resistance spot welding process. In particular, during a resistance spot welding event, the indexing feature may be involved in passing electrical current between the welding arm and the carrier and, additionally, may bear forces exerted on the carrier. When the indexing feature is a protrusion and a recess mated together, for example, electrical current may be passed between the weld gun arm and the carrier through the mated protrusion/recess in order to facilitate passage of the electrical current through a workpiece stack-up using the welding electrode associated with the indexed position of the carrier. And, during such time that electrical current is being passed through the workpiece stack-up, forces (e.g., from the clamping force imposed on the welding electrodes by the weld gun arms) exerted on the carrier may be borne by the mated protrusion/recess. In one specific instance, the carrier is forced toward the weld gun arm—with the protrusion and the recess mated together to provide an indexing feature—to overcome an oppositely-directed biasing force applied against the carrier.

### BRIEF DESCRIPTION OF THE DRAWINGS

FIG. 1 is a side view of a resistance spot welding assembly;

FIG. 2 is a top view of a weld gun arm with a pair of welding electrodes supported on a carrier;

FIG. 3 is a side view of the weld gun arm of FIG. 2;

FIG. 4 is a side view of another resistance spot welding assembly; and

FIG. 5 is a side view of the resistance spot welding assembly of FIG. 1, but with the workpieces inserted deeper between weld gun arms.

### DETAILED DESCRIPTION

The methods and assemblies detailed in this description resolve shortcomings encountered when resistance spot welding workpiece stack-ups of different combinations of steel workpieces and aluminum or aluminum alloy (again, referred to collectively as “aluminum”) workpieces. A weld gun arm is described that has a rotatable carrier supporting a pair of welding electrodes. One welding electrode is preferably suited for making contact with a steel workpiece while the other welding electrode is preferably suited for making contact with an aluminum workpiece. The carrier is constructed to promptly exchange the welding electrodes, as needed, as steel and aluminum workpiece combinations become available for resistance spot welding. Workpiece stack-ups comprised of steel-to-steel workpieces, aluminum-to-aluminum workpieces, and steel-to-aluminum workpieces can be resistance spot welded at any time and in any order in a single resistance spot welding operation line more efficiently and flexibly than previously possible. Indeed, interchanging dedicated and distinct weld guns is no longer required, nor is a dressing step needed to alter and repurpose the weld face geometry of a single welding electrode based on the composition of the workpiece it will be pressed against during spot welding (although the welding electrodes supported on the carrier may still be periodically redressed to remove contaminants and to recreate their weld faces).

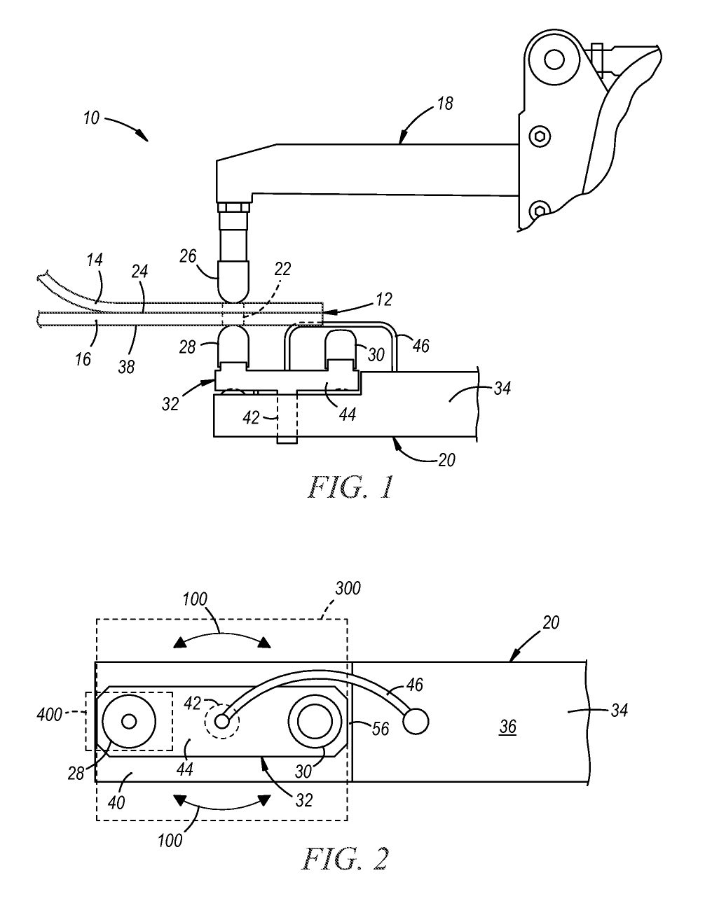

FIG. 1 depicts one example of a resistance spot welding assembly 10 that can be used to resistance spot weld a workpiece stack-up 12 having a first workpiece 14 and a second workpiece 16 that overlay and contact each other. The workpiece stack-up 12 could include yet additional workpieces although not explicitly shown here. The first and second workpieces 14, 16 can have thicknesses that are the same as each other or are different from each other. Each of the first and second workpieces 14, 16 may, for example, have a thickness that ranges between 0.3 mm and 6.0 mm, between 0.5 mm and 4.0 mm, and more narrowly between 0.6 mm and 2.5 mm; still, other thickness values are possible. The term “workpiece” is used broadly in this description to refer to any resistance spot weldable substrate including a sheet metal layer, a casting, and an extrusion, inclusive of any surface layers or coatings that may be present.

The first workpiece 14 can be a coated or uncoated steel substrate or a coated or uncoated aluminum substrate, and the second workpiece 16 can likewise be a coated or uncoated steel substrate or a coated or uncoated aluminum substrate. Depending on the compositions of their constituent workpieces, the workpiece stack-up 12 could be made up of all steel workpieces, all aluminum workpieces, or one or more steel workpieces and one or more aluminum workpieces. A steel workpiece includes a steel substrate that can be galvanized (i.e., zinc coated), aluminum coated, or bare (i.e., uncoated). The coated or uncoated steel substrate may be composed of any of a wide variety of steels including a low carbon steel (also referred to as mild steel), an interstitial-free (IF) steel, a high-strength low-alloy (HSLA) steel, or an advanced high strength steel (AHSS) such as dual phase (DP) steel, transformation-induced plasticity (TRIP) steel, twinning-induced plasticity (TWIP) steel, complex-phase (CP) steel, martensitic (MART) steel, hot-formed (HF) steel, and press-hardened (PHS) steel.

An aluminum workpiece includes an aluminum substrate that may be coated or bare (i.e., no natural or applied surface coatings). The coated or uncoated aluminum alloy substrate may be composed of aluminum, an aluminum-magnesium alloy, an aluminum-silicon alloy, an aluminum-magnesium-silicon alloy, or an aluminum-zinc alloy. The aluminum substrate, for example, may be composed of a 4xxx, 5xxx, 6xxx, or 7xxx series wrought aluminum alloy sheet layer, or a 4xx.x, 5xx.x, or 7xx.x series aluminum alloy casting, and may further be employed in a variety of tempers including annealed (O), strain hardened (H), and solution heat treated (T). Some more specific kinds of aluminum that can be used as the aluminum alloy substrate include, but are not limited to, 5754 aluminum-magnesium alloy, 6022 aluminum-magnesium-silicon alloy, 7003 aluminum-zinc alloy, and Al-10Si-Mg aluminum die casting alloy. In addition, these and other suitable aluminum materials may be coated with their natural refractory oxide layer(s), zinc, or a conversion coating, and weld-through adhesives or sealers that are normally used in resistance spot welding operations may also be present.

Still referring to FIG. 1, the resistance spot welding assembly 10 is typically a part of a larger automated welding operation that includes a first weld gun arm 18 and a second weld gun arm 20. The weld gun arms 18, 20 are, in general, mechanically and electrically configured to repeatedly make resistance spot welds in rapid succession on a welding operation line such as those found in an automotive manufacturing plant. A C-type welding gun could be equipped with the first and second weld gun arms 18, 20, where one of the arms remains stationary while the other reciprocates back and forth during spot welding. Or an X-type welding gun could be equipped with the first and second welding gun arms 18, 20, where both arms advance toward each other and retract away from each other during spot welding. Still, the first and second weld gun arms 18, 20 could be equipped in other types of welding guns not specifically mentioned here.

Amid resistance spot welding operations, the weld gun arms 18, 20 press their respective welding electrodes against opposite sides and outer surfaces of the overlaid workpieces 14, 16 at a weld site 22, with accompanying weld faces of the electrodes aligned across and with each other. A faying interface 24 is located between the first and second workpieces 14, 16 at confronting and abutting faying surfaces of the workpieces 14, 16. The faying interface 24 encompasses instances of direct contact between the workpiece faying surfaces, as well as instances of indirect contact where the faying surfaces are not in direct contact but are in close enough proximity to each another—such as when a thin layer of adhesive, sealer, or some other intermediate material is present—that resistance spot welding can still be practiced.

In the embodiment presented by FIG. 1, the first weld gun arm 18 can remain stationary or can move during the welding action. The first weld gun arm 18 has a first welding electrode 26 confronting the first workpiece 14 at the weld site 22. The first welding electrode 26 can be designed and constructed for pressing against a steel workpiece or an aluminum workpiece, and its weld face geometry and/or material may differ for a workpiece composed of steel and a workpiece composed of aluminum. For a steel workpiece, the first welding electrode 26 can possess a weld face geometry with a diameter between 4 mm to 10 mm and a radius of curvature between 20 mm to flat. The first welding electrode 26 can additionally be composed of a copper alloy having an electrical conductivity of at least 80% of the electrical conductivity of commercially pure annealed copper as defined by the IACS. One specific example of such a copper alloy is a copper-zirconium alloy (ZrCu) that contains about 0.10 wt. % to about 0.20 wt. % zirconium and the balance copper. Copper alloys that meet this constituent composition and are designated C15000 are generally preferred.

For an aluminum workpiece, on the other hand, the first welding electrode 26 can possess a weld face geometry with a diameter between 6 mm to 20 mm, or more narrowly between 8 mm to 12 mm, and a radius of curvature between 12 mm to 300 mm, or more narrowly between 20 mm to 150 mm. And, for aluminum, the first welding electrode 26 can be composed of a suitable copper alloy such as C15000, can be composed so that at least its weld face is composed of a refractory-based material such as a tungsten-copper alloy. Still, other features of the first welding electrode 26 may change depending on whether the electrode 26 confronts and is to be pressed against an aluminum or steel workpiece. For instance, for an aluminum workpiece, the weld face of the first welding electrode 26 may have surface features to penetrate oxide layers formed on the outer surface of the aluminum workpiece. Examples include texturing and designs and constructions such as those described in U.S. Pat. Nos. 6,861,609; 8,222,560; 8,274,010; 8,436,269; 8,525,066; and 8,927,894; and in U.S. patent application publication number 2014/0076859.

The second weld gun arm 20 has a different design and construction than the first weld gun arm 18. The second weld gun arm 20 can remain stationary or can move during the welding action. But perhaps most conspicuously, the second weld gun arm 20 carries a pair of welding electrodes instead of just one. The second weld gun arm 20 could have more than two welding electrodes in other embodiments. In FIG. 1, a second welding electrode 28 can be designed and constructed for pressing against one of a steel workpiece or an aluminum workpiece, and a third welding electrode 30 can be designed and constructed for pressing against the other of a steel or aluminum workpiece. With one welding electrode suited to engage steel during spot welding and the other suited to engage aluminum during spot welding, the second weld gun arm 20 can accommodate the second workpiece 16 made of any of these materials. In the embodiment presented by FIGS. 1-3, the second welding electrode 28 is tailored for use with a steel workpiece, and therefore can possess the weld face geometries and can be made of the materials set forth above for steel. The third welding electrode 30, on the other hand, is tailored for use with an aluminum workpiece, and therefore can possess the weld face geometries and can be made of the materials set forth above for aluminum.

The second and third welding electrodes 28, 30 are not necessarily limited to constructions that can accommodate pressed engagement with steel workpieces and aluminum workpieces, respectively, as shown in FIG. 1. In other embodiments, for instance, the second and third welding electrodes 28, 30 could be tailored for use with steel workpieces of different gauges—one for a thicker steel workpiece and the other for a thinner steel workpiece. Or the second and third welding electrodes 28, 30 could be tailored for use with thicker and thinner aluminum workpieces. Still further, the second and third welding electrodes 28, 30 could be tailored for use with the same workpiece, whether aluminum or steel, and therefore the electrodes 28, 30 could have the same design and construction.

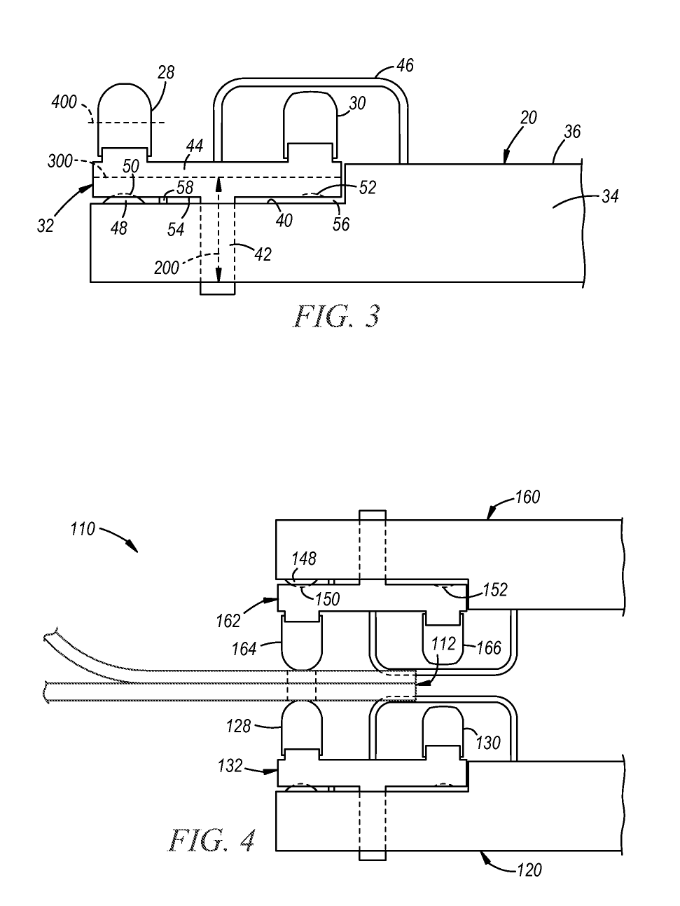

Referring particularly to FIGS. 2 and 3, the second weld gun arm 20 is equipped with a rotatable carrier 32 that supports both of the second and third welding electrodes 28, 30. The carrier 32 exchanges the welding electrodes 28, 30, as needed, depending on which welding electrode 28, 30 is desired to be used with the second workpiece 16 of the workpiece stack-up 12. The exchange can occur promptly and on-the-fly in the midst of performing a series of successive resistance spot welds in a welding operation line. For instance, the second workpiece 16 may be an aluminum workpiece in one stack-up 12, may be a steel workpiece in the next stack-up 12, and may again be a an aluminum workpiece in the following stack-up, with the carrier 32 working to exchange the second and third welding electrodes 28, 30 to bring the appropriate welding electrode to the weld site 22 (second electrode 28 for the steel workpieces and third electrode 30 for the aluminum workpieces) to be placed in axial alignment with the first welding electrode 26 with little to no interruption of the welding operation.

The kind of process efficiency and flexibility attributed to the carrier 32 may be regularly called for in a welding operation line involving vehicle components where steel-to-steel, aluminum-to-aluminum, and steel-to-aluminum workpieces are increasingly more common among components of different makeup and materials. Exchanging the second and third welding electrodes 28, 30 through rotation of the carrier 32 can occur faster than interchanging dedicated and distinct weld guns or repeatedly dressing a single welding electrode to alter its weld face geometries to match the composition of the workpiece it will be brought into contact with. The second weld gun arm 20 and its carrier 32, moreover, are considerably less costly than furnishing dedicated and distinct welding machines for resistance spot welding the different workpiece combinations (steel-to-steel, aluminum-to-aluminum, and steel-to-aluminum) that may be contained in the workpiece stack-up 12. Furthermore, having a single weld gun arm with exchangeable welding electrodes frees-up manufacturing floor space that might otherwise be occupied by weld guns meant for aluminum workpieces and weld guns meant for steel workpieces.

In the embodiment shown in FIG. 1, the carrier 32 exchanges the second and third welding electrodes 28, 30 through rotational movement 100, as depicted in FIG. 2. The rotational movement 100 can be a swivel movement about a single axis 200 (FIG. 3) and with respect to a body 34 of the second weld gun arm 20. The swivel movement can be in one direction (clockwise or counterclockwise) or can be in both directions (clockwise and counterclockwise) as the second and third welding electrodes 28, 30 are exchanged for each other. The carrier 32 may move one-hundred-and-eighty degrees (180°) between a first position and a second position. In the first position, the weld face of the second welding electrode 28 confronts and is axially aligned with the weld face of the first welding electrode 26, and in the second position the weld face of the third welding electrode 30 confronts and is axially aligned with the weld face of the first welding electrode 26.

The first position is shown in FIGS. 1, 2, and 3. The second position, although not shown in the Figures, would have the third welding electrode 30 in place of the second welding electrode 28 in FIGS. 1, 2, and 3 while the second welding electrode 28 would in turn take the place of the third welding electrode 30. In the first position, the third welding electrode 30 is situated at a non-working location away from the weld site 22 and does not participate in current exchange with the first welding electrode 26 or any other significant aspect of a resistance spot welding process. Similarly, in the second position, the second welding electrode 28 would be situated at the non-working location and would not participate in current exchange with the first welding electrode 26 or any other significant aspect of a resistance spot welding process. Still, the movement and positions can vary from what has been described; for example, the carrier 32 does not necessarily have to swivel one-hundred-and-eighty-degrees) (180° between the first and second positions so long as the second and third welding electrodes 28, 30 are adequately spaced on the carrier 32 to permit functional interchangeability of the electrodes 28, 30.

Between the first and second positions, the carrier 32 swivels over an imaginary swivel plane 300, as shown best in FIG. 2. The swivel plane 300 is generally orthogonal to the axis 200 and generally parallel to a planar face surface 36 of the body 34. The swivel plane 300 is also generally parallel to an imaginary transverse plane 400 cut through the second and/or third welding electrodes 28, 30 (the transverse plane is only depicted at the first welding electrode for simplification). The transverse plane 400 may be a cross-sectional plane of the second and third welding electrodes 28, 30 and orthogonal to the lengthwise extents of the welding electrodes 28, 30. Further, in the example of FIG. 1, the swivel plane 300 is generally parallel to a confronting surface 38 of the second workpiece 16 at least at the weld site 22. While not all of these relationships need to be true in all embodiments, having the carrier 32 rotate in the manner described can satisfy packaging and weld-site-access challenges encountered in automotive applications that are sometimes uncompromising.

The carrier 32 can have different designs and constructions, which may be dictated by the design and construction of the second weld gun arm 20. In the embodiment illustrated in FIGS. 2 and 3, the carrier 32 can be composed at least partly of a material exhibiting a suitable electrical conductivity of 45% or more of the electrical conductivity of commercially pure, annealed copper as defined by the International Annealed Copper Standard (100% IACS is defined as 5.80×10⁷ S/m). Once such electrically conductive material is a hard copper alloy, like a beryllium-copper alloy, designated as a Resistance Welding Manufacturing Alliance (RWMA) class 3 copper alloy. The electrically conductive material—whether making up the entirety of the carrier 32 or portions or parts of it—provides an electrical current flow pathway through the carrier and leading to the second and third welding electrodes 28, 30. In a similar way, the body 34 of the second weld gun arm 20 can be composed of a suitably electrically conductive material in order to pass current to the carrier 32.

In this embodiment, the carrier 32 has a stem 42 and a base 44, and is seated in a cutout 40 of the body 34. In other embodiments, the cutout 40 need not be provided. The stem 42 can be coupled to the body 34 for rotation as the carrier 32 moves, and can be fitted with bearings to assist the rotation. An electrically insulating cover or material such as an adhesive, coating, or jacket could be set around the stem 42 in order to shield the stem and preclude electrical current flow between the body 34 of the second weld gun arm 20 and the stem 42. The base 44 is centered about the stem 42 and can support the second and third welding electrodes 28, 30 near its ends by any type of suitable mounting. The base 44 has a lengthwise extension that generally matches that of the cutout 40, and has a widthwise extension that is narrower than that of the body 34. The lengthwise and widthwise extensions of the base 44, as well as its size and shape, can configure the base 44 appropriately to lack or minimize structures that might interfere with the resistance spot welding procedure. Further, in both the first and second positions, the lengthwise extent of the base 44 can be in general alignment with the lengthwise extent of the body 34 so as to again avoid potential interference with the welding procedure. This alignment is perhaps shown best by the top view of FIG. 2 in which the base 44 and body 34 appear in-line with each other along the horizontal direction in the Figure.

The first and second welding electrodes 28, 30, the carrier 32, the base 44, and the second gun arm 20 can be arranged at various angles relative to the upper gun arm 18. For instance, although not shown specifically in the Figures, the first and second welding electrodes 28, 30, the carrier 32, the base 44, and the second gun arm 20 can be angled away or tilted from the second workpiece 16 to further distance the welding electrode that is not being used to exchange current from the second workpiece 16 if additional clearance is desired. Such tilting can be accommodated by angling the welding electrodes 28, 30 on the carrier 32—by use of fixed mounting features on the carrier 32 or permanent or temporary adaptors—to counter the tilt of the second gun arm 20 in order to maintain contact between the weld face of whichever welding electrode is being used to exchange current and the second workpiece 16.

The carrier 32 can have yet additional designs and constructions that facilitate its functionality during use. For example, the carrier 32 could be actuated between the first and second positions by a rack-and-pinion assembly, a pneumatic or hydraulic actuator assembly, a servomotor, or some other type of actuation technique. The carrier 32 could have a cooling system meant to keep the carrier and its welding electrodes 28, 30 at an acceptable temperature and avoid overheating amid welding. The cooling system could include external cooling lines 46 and internal cooling lines for circulating coolant through the carrier 32 and to the electrodes 28, 30. The coolant is preferably water but, of course, is not so limited and could be something else.

Depending on how the carrier 32 is actuated, the carrier 32 may be indexed at the first and second positions. The indexing can be carried out at each of the first and second positions by an indexing feature such as a protrusion and a recess mated together. In the embodiment shown best in FIG. 3, for example, the body 34 of the second weld gun arm 20 includes a protrusion 48 and a bottom surface 54 includes a second recess 50 and a third recess 52. The protrusion 48 has a rounded shape and projects slightly above its surrounding surface at the cutout 40. And, as depicted in FIG. 3, the protrusion 48 is located underneath the second welding electrode 28 when the carrier 32 is put in the first position. Alternatively, if a servomotor is used to rotate the carrier 32, the degree of rotation can be easily controlled by programming the servomotor. Under such instances, indexing features may not necessarily be needed, although they certainly can be used in conjunction with a servomotor.

The second and third recesses 50, 52 are shaped to receive insertion of the protrusion 48 and, as such, have a complementary rounded shape to that of the protrusion 48. Here, the recesses 50, 52 are depressions set into the bottom surface 54 of the carrier 32, with the second recess 50 being located underneath the second welding electrode 28 and the third recess 52 being located underneath the second welding electrode 30. FIG. 3 illustrates the protrusion 48 and the second recess 50 mated together, thus establishing an indexing feature that indexes the carrier 32 in the first position. Likewise, and although not shown, the protrusion and third recess 52 can be similarly mated together to establish an indexing feature that indexes the carrier 32 in the second position upon rotation of the carrier 32. The mated protrusion 48 and recess 50, 52 keep the carrier 32 in the first or second position during resistance spot welding. Still, in other embodiments, the indexing feature can take on different shapes, sizes, and locations than those shown and described here; for example, two protrusions could extend from the bottom surface 54 of the carrier 32 (in place of the second and third recesses 50, 52) and a single recess could be located in the body 34 (in place of the protrusion 48) to achieve the same indexing effect.

In addition to its use in indexing, the indexing feature (comprised in this embodiment by the protrusion 48 and one of the recesses 50, 52) can also be used to pass electrical current during welding, to bear forces exerted during welding, or both. To pass electrical current, the protrusion 48 may be composed of a material exhibiting a suitable electrical conductivity such as the materials set forth above with respect to the carrier 32—e.g., a hard copper alloy material like a beryllium-copper RWMA class 3 alloy—such that electrical current can pass between the protrusion and the body 34 of the second weld gun arm 20 and ultimately through the carrier 32 when an indexing feature is established. For instance, when the carrier 32 is indexed in the first position as shown in FIG. 3, electrical current passes through the body 34 of the second weld gun arm 20, through the protrusion 48, through the mating recess 50, through the carrier 32, and to the first welding electrode 28, or vice versa if current is flowing in the opposite direction. And when the carrier is indexed in the second position, electrical current passes through the body 34 of the second weld gun arm 20, through the protrusion 48, through the mating recess 52, through the carrier 32, and to the second welding electrode 30 or vice versa if current is flowing in the opposite direction.

Electrical current is preferably delivered to the carrier 32 only by way of the mated protrusion 48 and recess 50 or 52. Indeed, as described above, the stem 42 of the carrier 32 is electrically insulated and therefore cannot exchange electrical current with the body 34 of the second weld gun arm 20. Moreover, to further isolate the flow of current through an indexing feature only, a gap 56 is present between the bottom surface 54 of the carrier 32 and a confronting surface of the body 34. This gap 56 precludes unwanted physical contact between the carrier 32 and the body 34 and is large enough to prevent electric discharge between the carrier 32 and the body 34 given the current levels employed in during resistance spot welding events. The only physical contact between the carrier 32 and body 34 during resistance spot welding, and thus the only conduit for electrical current flow between the two, is through the protrusion 48 and one of the second or third recesses 50 or 52 depending on the position of the carrier (first or second indexed position).

When the second weld gun arm 20 presses the first or second welding electrode 28, 30 against the second workpiece 16, forces are exerted on the carrier 32. In this embodiment, between the carrier 32 and body 34, those forces are borne by the mated protrusion 48 and recess 50 or 52. The protrusion 48 and recesses 50, 52 are designed and constructed to possess sufficient robustness to bear the exerted forces associated with repetitive spot welding events. The forces are therefore transmitted from the carrier 32 and to the body 34 by way of the mated protrusion 48 and recess 50 or 52.

Furthermore, one or more springs 58 may be provided between the bottom surface 54 of the carrier 32 and the body 34 of the second weld gun arm 20 to assist separating the mated protrusion 48 and the recess 50 or 52 and to bring them to an unmated state. The one or more springs 58 yield to the forces exerted on the carrier 32 when the second or third welding electrodes 28, 30 is clamped against the second workpiece 16 in preparation for and during spot welding, which in turn establishes mating between the protrusion 48 and recess 50 or 52. Conversely, when second or third welding electrodes 28, 30 is not clamped against the second workpiece 16, the one or more springs 58 bias the carrier 32 and body 34 away from each other. The protrusion 48 and recess 50 or 52 are thus more easily brought to the unmated state with the spring(s) 58, and clearance is therefore provided for the carrier 32 to rotate and exchange the first and second welding electrodes 28, 30 when desired.

Having the indexing feature pass electrical current and/or bear forces removes the need for a construction elsewhere in the carrier 32 and the body 34 to fulfill these same functionalities. Previously-known constructions for passing electrical current and enduring forces for similar purposes are more involved than desired in some cases. For instance, cables and laminated shunts are sometimes used for passing electrical current and various structures are used for enduring forces. While the cables, laminated shunts, and structures may still be suitable in some embodiments, the protrusion 48 and recesses 50, 52 are comparatively much simpler.

FIG. 4 depicts another embodiment of a resistance spot welding assembly 110. Similar components between this embodiment and that of FIGS. 1-3 have reference numerals differing by the addition of number one-hundred (100). Descriptions of the similar components may not necessarily be repeated here. In the embodiment of FIG. 4, a second weld gun arm 120 is the same as the second weld gun arm 20 of FIGS. 1-3. In brief, the second weld gun arm 120 has a carrier 132 that supports second and third welding electrodes 128, 130, as previously described.

A first weld gun arm 160 of the assembly 110, however, has a different design and construction than the first weld gun arm 18 of FIGS. 1-3. As depicted in FIG. 4, the first weld gun arm 160 has the same design and construction as the second weld gun arm 120. The first weld gun arm 160 has a second carrier 162 that supports a first welding electrode 164 and a fourth welding electrode 166. The second carrier 162 and the third and fourth welding electrodes 164, 166 have the same design, construction, and functionality as the carrier 32 previously described with reference to FIGS. 1-3. For instance, the third welding electrode 164 is tailored for use with a steel workpiece, and the fourth welding electrode 166 is tailored for use with an aluminum workpiece. The second carrier 162 exchanges the third and fourth welding electrodes 164, 166 through a rotational movement and between first and second positions. And the second carrier 162 is indexed between its first and second positions by an indexing feature, such as a protrusion 148 mated with first or fourth recess 150, 152, which can also be used to pass electrical current and/or bear exerted forces during welding. The embodiment of FIG. 4 may provide even greater efficiency and flexibility when resistance spot welding different combinations of steel workpieces and aluminum workpieces in a workpiece stack-up 112.

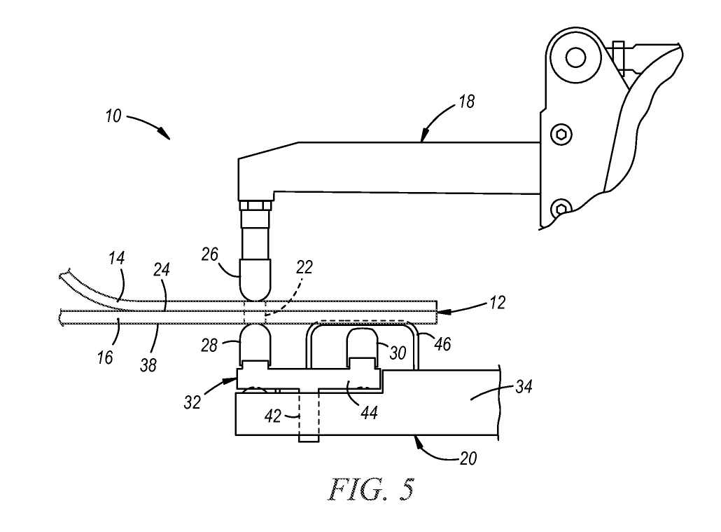

Lastly, it should be appreciated that the Figures depict the components of the resistance spot welding assembly 10 schematically, and that certain designs and constructions will inevitably be altered in production. For instance, the width, length, and shape of the carrier 32 and its base 44 can be modified. In applications in which the carrier 32 will be manipulated at a deep overlap with the workpiece stack-up 12 for performing a resistance spot weld, the base 44 can be lengthened considerably more than what is shown so that the non-working electrode is spaced away from a terminal edge of the workpiece stack-up 12 and would remain free-of-contact with the workpiece stack-up 12. Alternatively, as shown in FIG. 5, the third welding electrode 30 may be located adjacent to, and at an overlapping depth with, the workpiece stack-up 12. The third welding electrode 30 may remain free-of-contact with the workpiece stack-up 12 at such a location or it may make contact with the stack-up 12 since, at that particular location, current will not be exchanged between the first and third welding electrodes 26, 30. Also, the electrodes 28, 30 are illustrated on shorter electrode mounts to the carrier 32, and their mounts could be increased in height considerably more than what is shown.

The above description of preferred exemplary embodiments and related examples are merely descriptive in nature; they are not intended to limit the scope of the claims that follow. Each of the terms used in the appended claims should be given its ordinary and customary meaning unless specifically and unambiguously stated otherwise in the specification.

1. A method of resistance spot welding workpiece stack-ups of different combinations of steel workpieces and aluminum workpieces, the method comprising:
providing a first workpiece stack-up that includes a pair of steel workpieces or a pair of aluminum workpieces, and providing a second workpiece stack-up that includes a steel workpiece and an aluminum workpiece;
providing a first weld gun arm with a first welding electrode, and providing a second weld gun arm having a rotatable carrier that supports a second welding electrode and a third welding electrode;
bringing the first workpiece stack-up between the first and second weld gun arms, and passing electrical current through the first workpiece stack-up and between the first welding electrode and the second welding electrode;
rotating the carrier; and
bringing the second workpiece stack-up between the first and second weld gun arms, and passing electrical current through the second workpiece stack-up and between the first welding electrode and the third welding electrode.

2. The method as set forth in claim 1, wherein the third welding electrode confronts the aluminum workpiece and is axially aligned with the first welding electrode when passing electrical current through the second workpiece stack-up between the first and third welding electrodes.

3. The method as set forth in claim 1, further comprising:
providing the first weld gun arm with a fourth welding electrode, both the first and fourth welding electrodes being supported on a second carrier;
rotating the second carrier; and
bringing a third workpiece stack-up between the fourth welding electrode and the second or third welding electrode, and passing electrical current through the third workpiece stack-up between the fourth welding electrode and the second or third welding electrode.

4. The method as set forth in claim 1, wherein rotating the carrier involves indexing the carrier between a first position and a second position, the first and second welding electrodes being aligned with each other when the carrier is in the first position to pass electrical current between the first and second welding electrodes, and the first and third welding electrodes being aligned with each other when the carrier is in the second position to pass electrical current between the first and third welding electrodes.

5. The method as set forth in claim 4, wherein indexing the carrier at each of the first and second positions is carried out by an indexing feature that includes a protrusion and a recess mated together.

6. The method as set forth in claim 5, further comprising:
passing electrical current between the second weld gun arm and the carrier through the indexing feature that indexes the carrier in the first position when electrical current is being passed through the first workpiece stack-up between the first and second welding electrodes; and
passing electrical current between the second weld gun arm and the carrier through the indexing feature that indexes the carrier in the second position when electrical current is being passed through the second workpiece stack-up between the first and third welding electrodes.

7. The method as set forth in claim 6, wherein the indexing feature that indexes the carrier in the first position bears forces exerted on the carrier when electrical current is being passed through the first workpiece stack-up between the first and second welding electrodes, and wherein the indexing feature that indexes the carrier in the second position bears forces exerted on the carrier when electrical current is being passed through the second workpiece stack-up using the first and third welding electrodes.

8. The method as set forth in claim 5, wherein the second weld gun arm includes a protrusion and the carrier includes a second recess and a third recess in a bottom surface of the carrier underneath the second welding electrode and the third welding electrode, respectively, and wherein the step of indexing the carrier in the first position comprises receiving the protrusion in the second recess, and wherein the step of indexing the carrier in the second position comprises receiving the protrusion in the third recess.

9. The method as set forth in claim 1, further comprising feeding coolant to the carrier and to the second and third welding electrodes.

10. The method as set forth in claim 1, wherein rotating the carrier involves swiveling the carrier about a single axis and with respect to a body of the second weld gun arm.

11. The method as set forth in claim 1, wherein rotating the carrier involves swiveling the carrier about a swivel plane that is generally parallel to a transverse plane of the second welding electrode, of the third welding electrode, or of both the second and third welding electrodes.

12. The method as set forth in claim 1, wherein the second and third welding electrodes are composed of different materials, have different weld face geometries, or are composed of different materials and have different weld face geometries.

13. A method of resistance spot welding workpiece stack-ups of steel and aluminum workpiece combinations, the method comprising:
bringing a first workpiece stack-up between a first weld gun arm and a second weld gun arm, the first weld gun arm including a first welding electrode, and the second weld gun arm including a carrier that supports a second welding electrode and a third welding electrode;
indexing the carrier to a first position in which the second welding electrode confronts the first workpiece stack-up in alignment with a first weld site;
passing electrical current through the first workpiece stack-up at the first weld site and between the first and second welding electrodes;
bringing a second workpiece stack-up between the first weld gun arm and the second weld gun arm;
indexing the carrier to a second position in which the third welding electrode confronts the second workpiece stack-up in alignment with a second weld site; and
passing electrical current through the second workpiece stack-up at the second weld site and between the first and third welding electrodes.

14. The method as set forth in claim 13, wherein the first weld gun arm has a second carrier that supports the first welding electrode and a fourth welding electrode, the method further comprising:
indexing the second carrier to a first position, in which the first welding electrode confronts the first workpiece stack-up at the first weld site, or to a second position, in which the fourth welding electrode confronts the first workpiece stack-up at the first weld site;
passing electrical current through the first workpiece stack-up at the first weld site using the first or fourth welding electrodes and exchanging electrical current with the second welding electrode;
indexing the second carrier to the first position, in which the first welding electrode confronts the second workpiece stack-up at the second weld site, or to the second position, in which the fourth welding electrode confronts the second workpiece stack-up at the second weld site; and
passing electrical current through the second workpiece stack-up at the second weld site using the first or fourth welding electrode and exchanging electrical current with the third welding electrode.

15. The method as set forth in claim 13, wherein indexing the carrier to the first position involves rotating the carrier about an axis and with respect to a body of the second weld gun arm.

16. The method as set forth in claim 13, wherein the second weld gun arm includes a protrusion and the carrier includes a second recess and a third recess in a bottom surface of the carrier underneath the second welding electrode and the third welding electrode, respectively, and wherein the step of indexing the carrier in the first position comprises receiving the protrusion in the second recess, and wherein the step of indexing the carrier in the second position comprises receiving the protrusion in the third recess.

17. The method as set forth in claim 16, wherein electrical current is introduced to the carrier through the protrusion and the second recess when mated together and the carrier is indexed to the first position or through the protrusion and the third recess when mated together and the carrier is indexed to the second position.

18. The method as set forth in claim 16, wherein forces exerted on the carrier are borne by the protrusion when received in either the second recess or the third recess.

19. The method as set forth in claim 13, further comprising biasing the carrier to facilitate indexing of the carrier to the first and second positions.

20. A method of resistance spot welding workpiece stack-ups of different combinations of steel workpieces and aluminum workpieces, the method comprising:
bringing a first workpiece stack-up between a first weld gun arm and a second weld gun arm, the first weld gun arm including a first welding electrode, and the second weld gun arm including a carrier that supports a second welding electrode and a third welding electrode;
passing electrical current through a weld site of the first workpiece stack-up and between the first and second welding electrodes when the carrier is at a first position and the first and second welding electrodes are axially aligned at the weld site of the first workpiece stack-up, the electrical current flowing through the carrier between the second welding electrode and the second weld gun arm via a protrusion that bears forces exerted on the carrier during passage of the electrical current between the first and second welding electrodes;
bringing a second workpiece stack-up between the first weld gun arm and the second weld gun arm;
rotating the carrier to a second position in which the first and third welding electrodes are axially aligned at a weld site of the second workpiece stack-up; and
passing electrical current through the weld site of the second workpiece stack-up and between the first and third welding electrodes, the electrical current flowing through the carrier between the third welding electrode and the second gun arm via a protrusion that bears forces exerted on the carrier during passage of the electrical current between the first and third welding electrodes.
